(19) United States
(12) Patent Application Publication
(10) Pub. No.: US 2026/0211645 A1
(43) Pub. Date: Jul. 23, 2026

(54) DEVICE AND METHOD FOR IDENTIFYING AND DETECTING REUSE OF OPEN-SOURCE SOFTWARE

(71) Applicant: SPARROW CO., LTD, Seoul (KR)

(72) Inventor: Woohyun ROH, Seoul (KR)

(21) Appl. No.: 19/455,458

(22) Filed: Jan. 21, 2026

(30) Foreign Application Priority Data
Jan. 23, 2025 (KR) 10-2025-0010165

(51) Int. Cl. G06F 8/36; G06F 21/57

(52) U.S. Cl. CPC G06F 8/36; G06F 21/577

(57) ABSTRACT

Disclosed are a device and method for identifying and detecting reuse of open-source software (OSS). The method includes a first operation of receiving an OSS project file from an OSS information database (DB) which updates an OSS DB with collected OSS information, and generating a structural equation modeling (SEM) model on the basis of the OSS project file; a second operation of updating, by the SEM model, an OSS embedding DB on the basis of new OSS information or a new OSS file; and a third operation of identifying, by the OSS embedding DB interoperating with the SEM model, specific OSS on the basis of an input project embedding generated on the basis of an input project for an analysis target.

### CROSS-REFERENCE TO RELATED APPLICATION

This application claims priority to and the benefit of Korean Patent Application No. 10-2025-0010165, filed on January 23, 2025, the disclosure of which is incorporated herein by reference in its entirety.

### BACKGROUND

### 1. Field of the Invention

The present invention relates to technology for source code comparison and static application analysis, and more particularly, to technology for identifying and detecting reuse of open-source software (OSS) using structural information of software.

### 2. Discussion of Related Art

Detecting the reuse of open-source software (OSS) requires continuous and accurate detection for license compliance awareness and software vulnerability management.

According to the related art, OOS is detected using a content-based reuse detection method or a token-based reuse detection method. In the content-based reuse detection method, raw content itself is hashed to detect the reuse of a complete duplication. In the token-based reuse detection method, variable names, function names, strings, constant values, etc., are abstracted to detect the reuse of modified code.

The above-described detection methods may yield meaningful OSS reuse detection results for the reuse of perfect duplications or reuse involving merely name changes. However, in the complex design and development environments of latest software, reuse extends beyond simple reuse to include modifications, additions, deletions, alterations, etc., in accordance with actual usage environments, which imposes clear limitations on the detection performance of the related art.

### SUMMARY OF THE INVENTION

The present invention has been derived to meet the requirements of the above-described related art and is directed to providing, as technology for source code comparison and static application analysis, a device and method for identifying and detecting reuse of open-source software (OSS) using structural information of software.

According to an aspect of the present invention, there is provided a device for identifying and detecting reuse of OSS, the device including: an OSS information database (DB) configured to receive collected OSS information and update an OSS DB; a structural equation modeling (SEM) training model configured to receive an OSS project file from the OSS information DB and generate an SEM model on the basis of the OSS project file; an OSS embedding DB connected to the SEM model; and a client module configured to receive an input project in accordance with an analysis target selection by a user terminal and generate an input project embedding through the SEM model. The OSS embedding DB is updated with a new OSS file updated in the OSS information DB on the basis of new OSS information from an OSS monitoring module. The client module receives information on identified OSS from the OSS embedding DB. The information on the identified OSS is used for obtaining vulnerabilities or license information from the OSS information DB.

The SEM model may identify specific OSS by comparing the input project embedding with embeddings in the OSS embedding DB.

The device for identifying and detecting reuse of OSS (hereinafter, “OSS detection device”) may further include a web module connected to the client module and the OSS information DB.

The web module may receive the information on the identified OSS from the client module, query the OSS information DB using the information on the identified OSS, and receive the vulnerabilities or the license information corresponding to the information on the identified OSS from the OSS information DB.

The web module may transmit the information on the identified OSS including the vulnerabilities or the license information to the user terminal.

According to another aspect of the present invention, there is provided a method of identifying and detecting reuse of OSS, the device including: a first operation of receiving an OSS project file from an OSS information DB which updates an OSS DB with collected OSS information, and generating an SEM model on the basis of the OSS project file; a second operation of updating, by the SEM model, an OSS embedding DB on the basis of new OSS information or a new OSS file; and a third operation of identifying, by the OSS embedding DB interoperating with the SEM model, specific OSS on the basis of an input project embedding generated on the basis of an input project for an analysis target.

The first operation may include: collecting, by an OSS collection module, OSS information from a system that collects information from the Internet; updating the OSS

information DB with the collected OSS information; and generating, by an SEM training module receiving the OSS project file from the OSS information DB, the SEM model.

The first operation may further include generating, by the SEM training module, the OSS embedding DB.

The second operation may include: receiving, by the OSS information DB, new OSS information from an OSS monitoring module that monitors the world wide web (WWW); updating the OSS information DB with the new OSS information; forwarding, by the OSS information DB, the new OSS file to the SEM model; and updating, by the SEM model, the OSS embedding DB with the new OSS file.

The third operation may include: receiving, by a client module connected to the SEM model and the OSS embedding DB, an input project in accordance with an analysis target selection by a user terminal; generating, by the SEM model, the input project embedding on the basis of the input project; comparing, by the SEM model, the input project embedding with embeddings in the OSS embedding DB; and receiving information on the identified OSS in accordance with comparison results from the OSS embedding DB.

The method (hereinafter “OSS detection method”) may further include a fourth operation of acquiring vulnerabilities or license information from the OSS information DB on the basis of information on the identified OSS and managing an OSS version.

The fourth operation may include: receiving, by a web module interoperating with the OSS information DB, the information on the identified OSS from the client module; querying the OSS information DB using the information on the identified OSS; and receiving the vulnerabilities or the license information corresponding to the information on the identified OSS from the OSS information DB.

The fourth operation may further include transmitting the information on the identified OSS including the vulnerabilities or the license information to a user terminal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an illustrative diagram explaining a semantic analysis process for a single file that may be employed in a method of identifying and detecting reuse of open-source software (OSS) according to an embodiment of the present invention;

FIG. 2 is an operational flowchart illustrating the principle of a system for identifying and detecting reuse of OSS according to another embodiment of the present invention;

FIG. 3 is a flowchart illustrating a method of identifying and detecting reuse of OSS according to still another embodiment of the present invention;

FIG. 4 is a flowchart illustrating a process of identifying and detecting reuse of OSS that is additionally applicable to the method of FIG. 3; and

FIG. 5 is a schematic block diagram of a device for identifying and detecting reuse of OSS according to yet another embodiment of the present invention.

### DETAILED DESCRIPTION OF EXEMPLARY EMBODIMENTS

While the present invention is subject to various modifications and may have a variety of embodiments, particular embodiments are illustrated in the drawings and described in detail. However, this is not intended to limit the present invention to specific forms of implementation, and is to be understood to include all modifications, equivalents, or substitutions that fall within the spirit and technical scope of the present invention.

Terms such as “first,” “second,” etc., may be used to describe various components, but the components are not limited by the terms. The terms are used solely for the purpose of distinguishing one component from others. For example, a first component may be named a second component, and similarly a second component may be named a first component, without departing from the scope of rights according to the present invention. The term “and/or” includes a combination of a plurality of stated associated items of any of the plurality of stated associated items.

In embodiments of the present application, “at least one of A and B” may represent “at least one of A or B” or “at least one combination of one or more of A and B.” In addition, in embodiments of the present application, “one or more of A and B” may represent “one or more of A or B” or “one or more combinations of one or more of A and B.”

When a component is referred to as “coupled” or “connected” to another component, it should be understood that the component may be directly coupled or connected to the other component or there may be still another component therebetween. On the other hand, when a component is referred to as “directly coupled” or “directly connected” to another component, it should be understood that there is no other component therebetween.

Terminology used in the present specification is used for describing particular embodiments only and is not intended to limit the present invention. Singular expressions include plural expressions unless context clearly indicates otherwise. As used herein, terms such as “include,” “have,” etc., are intended to indicate the presence of described features, numbers, steps, operations, components, parts, or combinations thereof, and are not intended to preclude the presence or addition of one or more other features, numbers, steps, operations, components, parts, or combinations thereof.

Unless otherwise defined, all terms used herein, including technical or scientific terms, have the same meaning as commonly understood by those of ordinary skill in the technical field to which the present invention pertains. Terms such as those defined in commonly used dictionaries should be construed as having meanings consistent with their meaning in the context of the relevant art and should not be construed as having an idealized or unduly formal meaning unless expressly defined in the present specification.

Hereinafter, exemplary embodiments of the present invention will be described in detail with reference to the accompanying drawings. In describing the present invention, to facilitate overall understanding, like reference numerals are used for like components in the drawings, and duplicate descriptions thereof will be omitted.

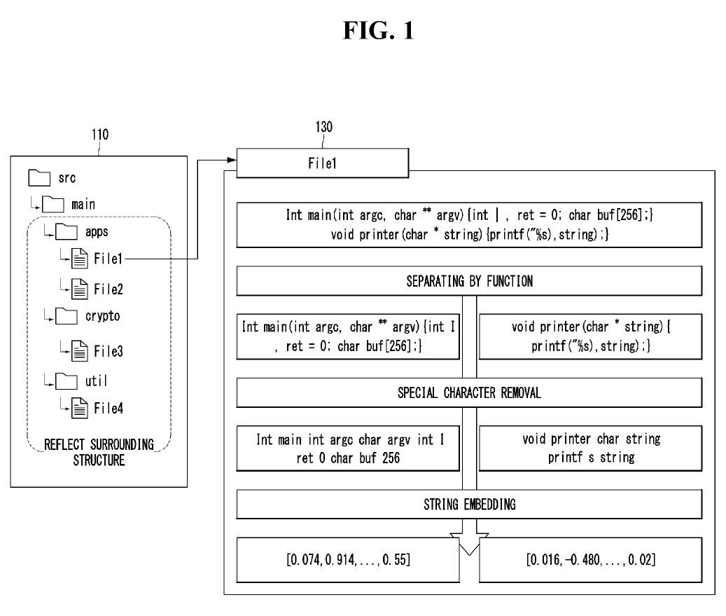

FIG. 1 is an illustrative diagram explaining a semantic analysis process for a single file that may be employed in a method of identifying and detecting reuse of open-source software (OSS) according to an embodiment of the present invention.

Referring to FIG. 1, a method of identifying and detecting reuse of OSS (hereinafter “OSS detection method”) may include a process of embedding individual files File1, File2, File3, and File4 of a source code 110 to project the meaning of the source code content and a configuration of words constituting the source code as a vector. In other words, an embedding of the structural meaning of the source code 110 may reflect the files in the source code 110 and a surrounding structure for relationships between the files.

For example, a method of embedding each individual file to analyze a structural meaning of the first file File1130 in the source code 110 may include separating by function, removing special characters, string embedding, and the like.

Separating by function may refer to analyzing the structure of text or code data within a file and dividing the analyzed structure into functional units or semantic units. According to a semantic analysis method based on separating by function, a computing device implementing this method may identify the structure of a file and preserve the meaning of the file in accordance with the identified structure or corresponding context. For example, the computing device may divide code into functions and express what each function does. Also, text data may dividedly be expressed or processed in semantic units.

Techniques for the foregoing separating by function may include a code-data meaning analysis method for extracting function names, parameters, return values, etc., from libraries within files using parsing tools for programming code analysis, natural language processing, etc., a general-text-data meaning analysis method for separating sentences into units of intent such as question, command, description, etc., using a sentence separation tool, and other methods.

Removing special characters may refer to eliminating special characters within the data of a file that distort meaning or are unnecessary for analysis. For example, removing special characters may include removing special characters from email or social media data or removing notes, non-essential symbols, spaces, and the like. Using this special character removal technique, it is possible to eliminate specific patterns from data within a file or convert the data into regular expressions.

String embedding may refer to a process of converting text data into the form of a vector such that an analytic model such as a machine learning model may understand the text data. In other words, embedding the structural meaning of a file may refer to representing the structural and contextual meaning of the file data in a space.

For example, string embedding may include word embedding, sentence embedding, code embedding, etc., to convert text data into low-dimensional continuous vectors or mathematically calculate the semantic similarity of data. Word embedding may be performed using a pretrained embedding model such as Word2Vec, Glove, or the like. Sentence embedding may be performed using a transformer-based model such as Bidirectional Encoder Representations from Transformer (BERT), Generative Pretrained Transformer (GPT), or the like. Code embedding may be performed using a dedicated code embedding model such as OpenAI Codex, Code BERT, or the like.

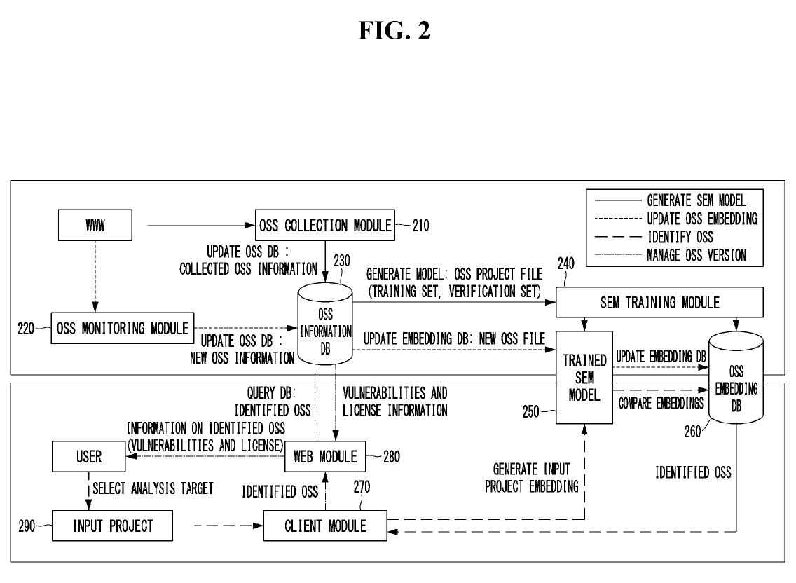

FIG. 2 is an operational flowchart illustrating the principle of a system for identifying and detecting reuse of OSS according to another embodiment of the present invention.

Referring to FIG. 2, a system for identifying and detecting reuse of OSS (hereinafter “OSS detection system”) may include a trained structural equation modeling (SEM) model 250. The OSS detection system may include a computing device including a repository or a processor equipped with the SEM model 250.

Also, the OSS detection system may further include an SEM training module 240 for training the SEM model 250. The SEM training module 240 may train the SEM model 250 using training datasets (hereinafter “training sets”) or verification datasets (hereinafter “verification sets”).

Also, the OSS detection system may further include an OSS information database (DB) 230 for providing an OSS project file for model generation to the SEM training module 240. The OSS project file may include training sets, verification sets, and the like.

Also, the OSS detection system may further include an OSS embedding DB 260 for storing and managing embeddings used by or output from the SEM model 250 that is trained by the SEM training module 240.

Also, the OSS detection system may further include an OSS collection module 210 for providing OSS information collected in the OSS information DB 230. The OSS information DB 230 may receive collected OSS information from the OSS collection module 210 and update an OSS DB on the basis of the collected OSS information. The OSS collection module 210 may collect the OSS information from the world wide web (WWW) which is a system enabling information sharing and access over the Internet, and the like.

Also, the OSS detection system may further include an OSS monitoring module 220 for providing new OSS information to the OSS information DB 230. The OSS information DB 230 may receive the new OSS information from the OSS monitoring module 220 and update the OSS DB with the new OSS information. The OSS monitoring module 220 may acquire the new OSS information from the WWW and the like.

Also, the OSS detection system may further include a web module 280 for querying the OSS information DB 230 about specific information or receiving specific information from the OSS information DB 230. The web module 280 may query the OSS information DB 230 about identified OSS on the basis of information on the identified OSS received from a client module 270 and acquire vulnerabilities, license information, etc., of the identified OSS from the OSS information DB 230.

The client module 270 may be included in the OSS detection system in a broad sense. The client module 270 may identify specific OSS when an analysis target is selected by a user and an input project 290 for the selected analysis target is generated or activated. In other words, the

client module 270 may function to provide the input project 290 from a user terminal to the trained SEM model 250 such that the SEM model 250 may generate an input project embedding. Here, the SEM model 250 may compare the input project embedding with embeddings prestored in the OSS embedding DB 260 and identify specific OSS on the basis of a preset similarity reference. The identified OSS may be forwarded from the OSS embedding DB 260 to the client module 270. The client module 270 may forward the identified OSS received from the OSS embedding DB 260 to the web module 280.

The web module 280 may forward the vulnerabilities and the license information received from the OSS information DB 230 to the user, that is, the user terminal, on the basis of the identified OSS. The vulnerabilities and the license information may be included in the information on the identified OSS.

As such, the OSS detection system of the present embodiment may be configured to generate an SEM model, update OSS embeddings of an OSS embedding DB on the basis of the SEM model, identify OSS of an analysis target on the basis of the updated OSS embeddings, acquire vulnerabilities or license information from the OSS information DB on the basis of the identified OSS, and provide the vulnerabilities and the license information to a user, thereby managing an OSS version.

An SEM model generation process may include an operation in which the OSS collection module 210 collects OSS information from the Internet or the like, an operation of updating the OSS DB of the OSS information DB 230 with the collected OSS information, and an operation in which the SEM training module 240 receiving the OSS project file from the OSS information DB 230 generates the SEM model 250. The SEM model generation process may further include an operation of generating the OSS embedding DB 260 by the SEM training module 240.

An OSS embedding update process may include an operation in which the OSS information DB 230 receives the new OSS information from the OSS monitoring module 220 monitoring the WWW, an operation of updating the OSS DB with the new OSS information, an operation of forwarding a new OSS file to the SEM model 250, and an operation in which the SEM model 250 updates the embedding DB of the OSS embedding DB 260 with the new OSS file.

An OSS identification process may include an operation in which the client module 270 receives the input project 290 in accordance with the selected analysis target from the user, an operation in which the SEM model 250 generates the input project embedding on the basis of the input project 290, an operation in which the SEM model 250 compares the input project embedding with embeddings in the OSS embedding DB 260, and an operation in which the client module 270 receives the OSS identified in accordance with the comparison results.

An OSS version management process may include an operation in which the web module 280 receives the identified OSS from the client module 270, an operation in which the web module 280 queries the OSS information DB 230 using the identified OSS, an operation in which the web module 280 receives the vulnerabilities or the license information corresponding to the information on the identified OSS from the OSS information DB 230, and an operation in which the web module 280 transmits the information on the identified OSS including the vulnerabilities, the license, etc., to the user terminal.

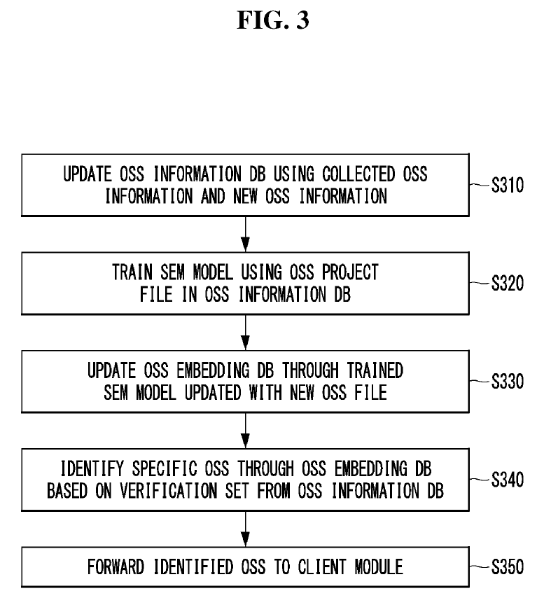

FIG. 3 is a flowchart illustrating a method of identifying and detecting reuse of OSS according to still another embodiment of the present invention.

Referring to FIG. 3, a device for identifying and detecting reuse of OSS that implements the OSS detection method (hereinafter “OSS detection device”) may update the OSS information DB using collected OSS information and new OSS information (S310).

Subsequently, the OSS detection device may generate and train an SEM model using OSS project files in the OSS information DB (S320).

Subsequently, the OSS detection device may update the OSS information DB with a new OSS file or new OSS information. In the OSS detection device, the SEM model may be updated with the new OSS file. Also, the SEM model may update the OSS embedding DB with the new OSS file (S330).

Subsequently, the OSS detection device may train the OSS embedding DB to identify specific OSS on the basis of verification sets from the OSS information DB. Also, the OSS detection device may compare an input project embedding which is generated by the SEM model 250 on the basis of an input project from the client module with embeddings in the OSS embedding DB and identify the specific OSS on the basis of a preset reference (S340).

Subsequently, the OSS detection device may forward the identified OSS from the OSS embedding DB to the client module (S350).

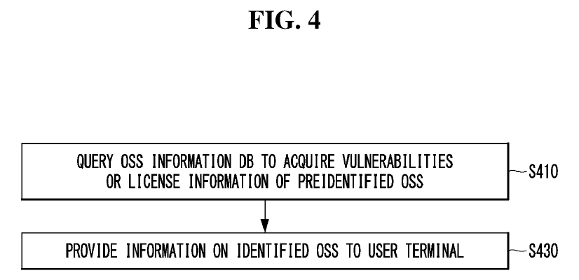

FIG. 4 is a flowchart illustrating a process of identifying and detecting reuse of OSS that is additionally applicable to the method of FIG. 3.

Referring to FIG. 4, the web module of the OSS detection device may receive the identified OSS from the client module and query the OSS information DB using the identified OSS, thereby acquiring vulnerabilities or license information of the identified OSS (S410).

Subsequently, the OSS detection device may provide information on the identified OSS to the user terminal (S430). The information on the identified OSS may include the vulnerabilities and/or the license information of the identified OSS retrieved from the OSS information DB.

Meanwhile, in the foregoing embodiment, the SEM training module may be configured to train the SEM model using maximum likelihood estimation, Bayesian inference, etc., solely or in

combination. Also, the SEM training module may include a data preprocessing module for appropriately inputting training sets or verification sets to the SEM model. Further, the SEM training module may include at least one functional module for cross-validation, model modification index calculation, variable addition/deletion, etc., to validate or fine-tune the SEM model.

In addition, in the foregoing embodiment, the SEM model may include a model that defines latent variables on the basis of relationships between embedding vectors and analyzes causal or correlational relationships therebetween. Here, the latent variables may refer to those used for modeling embedding vectors and may define relationships between similar embedding vectors. Similarities may be calculated by quantifying the relationships between embedding vectors as cosine similarities or Euclidean distances. These similarities may be used as observational variables. The observational variables may be used for analyzing relationships between the latent variables. The causal or correlational relationships between the latent variables may be referred to as structural paths. In other words, a structural path may be expressed as characteristics of a specific file influencing file similarity.

As such, the SEM model may define relationships between latent variables and observational variables on the basis of embeddings of source code or specific files and thus may be trained to ensure semantic similarities of latent variables closely correlating with cosine similarities. Also, the SEM model may define direct paths and indirect paths between latent variables on the basis of embeddings of source code or a specific file and thus may be trained to ensure structural similarity correlating with thematic relevance in OSS.

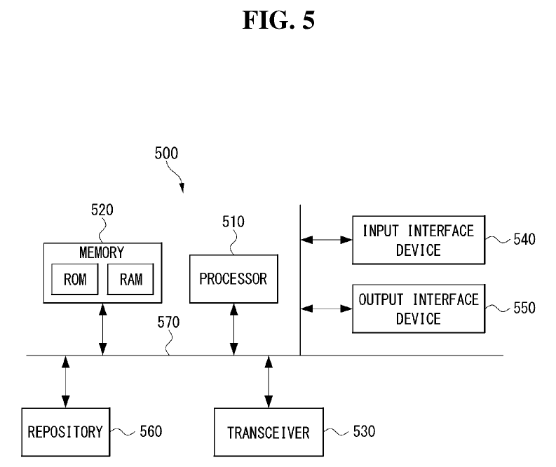

FIG. 5 is a schematic block diagram of a device for identifying and detecting reuse of OSS according to yet another embodiment of the present invention.

Referring to FIG. 5, a device for identifying and detecting reuse of OSS (hereinafter “OSS detection device”) 500 may include a processor 510 that executes at least one instruction. Also, the OSS detection device 500 may further include a memory 520 that is connected to the processor 510 and stores at least one instruction. Further, the OSS detection device 500 may be configured to selectively include at least one of a transceiver 530, an input interface device 540, an output interface device 550, a repository 560, and a DB system as necessary.

Components included in the OSS detection device 500 may be connected by a bus 570 to communicate with each other or may be connected through individual interfaces or individual buses centered around the at least one processor 510. For example, the processor 510 may be connected to at least one of the memory 520, the transceiver 530, the input interface device 540, the output interface device 550, and the repository 560 via at least one dedicated interface.

The processor 510 may execute program commands stored in at least one of the memory 520 and the repository 560. According to at least one instruction or program command, the processor 510 may be configured to perform an operation of updating an OSS information DB using collected OSS information and new OSS information, an operation of training an SEM model using an OSS project file in the OSS information DB, an operation of updating an OSS embedding DB through the pretrained SEM model which is updated with a new OSS file, an operation of identifying specific OSS on the basis of verification sets from the OSS information DB through the OSS embedding DB, and an operation of forwarding the identified OSS to a client module.

In addition, the processor 510 may be configured to further perform an operation of acquiring vulnerabilities or license information of the preidentified OSS by querying the OSS information DB, an operation of providing information on the identified OSS to a user terminal, or an operation of comparing analysis target OSS specified on the basis of input project embedding generation information with the identified OSS in the OSS embedding DB.

The above-described OSS detection device 500 may be implemented as at least a part of a communicable desktop computer, laptop computer, notebook, smartphone, tablet personal computer (PC), mobile phone, smart watch, smart glass, e-book reader, portable multimedia player (PMP), portable game machine, navigation device, digital camera, digital multimedia broadcasting (DMB) player, digital audio recorder, digital audio player, digital video recorder, digital video player, personal digital assistant (PDA), or the like.

The above-described OSS detection method according to the present embodiment may be implemented in the form of program commands that are executable by a computing device or various constituent elements corresponding thereto, and recorded on a computer-readable medium. The computer device or constituent elements corresponding thereto may include a processor and a memory. The computer-readable medium may include program commands, data files, data structures, etc., solely or in combination. The program commands recorded on the computer-readable medium may be those specially designed and configured for the present invention, or those known and available to those skilled in the field of computer software.

Examples of the computer-readable medium include hardware devices specially configured to store and execute program commands such as a read-only memory (ROM), a random access memory (RAM), a flash memory, and the like. Examples of the program commands include not only machine code such as those generated using a compiler but also high-level code that is executable by a computer using an interpreter or the like. The foregoing hardware device may be configured to operate as at least one software module in order to perform the OSS detection method according to the present invention, and vice versa.

According to the above-described present invention, when reuse in a broad sense such as a content modification, addition, deletion, alteration, etc., in accordance with actual usage environments rather than simple reuse is performed in the complex design and development environments of latest software, the reuse in a broad sense can be effectively identified and detected.

Also, according to the present invention, the structural information of software is handled as context constituting OSS. Accordingly, even when content is modified, high detection performance can be maintained.

Further, according to the present invention, not only the source code but also the structural information of OSS is embedded through embedding which is a text preprocessing technique for AI, such that the unique structural information can be fully preserved. Through this software source code processing, the reuse of OSS can be effectively detected.

Although the present invention has been described above with reference to embodiments, those of ordinary skill in the art should understand that various modifications and alterations of the present invention can be made without departing from the spirit or scope of the present invention described in the following claims.

What is claimed is:

1. A device for identifying and detecting reuse of open-source software (OSS), comprising:
an OSS information database (DB) configured to receive collected OSS information and update an OSS DB;
a structural equation modeling (SEM) training model configured to receive an OSS project file from the OSS information DB and generate an SEM model on the basis of the OSS project file;
an OSS embedding DB connected to the SEM model; and
a client module configured to receive an input project in accordance with an analysis target selection by a user terminal and generate an input project embedding through the SEM model,
wherein the OSS embedding DB is updated with a new OSS file updated in the OSS information DB on the basis of new OSS information from an OSS monitoring module,
the client module receives information on identified OSS from the OSS embedding DB, and
the information on the identified OSS is used for obtaining vulnerabilities or license information from the OSS information DB.

2. The device of claim 1, wherein the SEM model identifies specific OSS by comparing the input project embedding with embeddings in the OSS embedding DB.

3. The device of claim 1, further comprising a web module connected to the client module and the OSS information DB,
wherein the web module receives the information on the identified OSS from the client module, queries the OSS information DB using the information on the identified OSS, and receives the vulnerabilities or the license information corresponding to the information on the identified OSS from the OSS information DB.

4. The device of claim 3, wherein the web module transmits the information on the identified OSS including the vulnerabilities or the license information to the user terminal.

5. A method of identifying and detecting reuse of open-source software (OSS), comprising:
a first operation of receiving an OSS project file from an OSS information database (DB) which updates an OSS DB with collected OSS information, and generating a structural equation modeling (SEM) model on the basis of the OSS project file;
a second operation of updating, by the SEM model, an OSS embedding DB on the basis of new OSS information or a new OSS file; and
a third operation of identifying, by the OSS embedding DB interoperating with the SEM model, specific OSS on the basis of an input project embedding generated on the basis of an input project for an analysis target.

6. The method of claim 5, wherein the first operation comprises:
collecting, by an OSS collection module, OSS information from a system that collects information from the Internet;
updating the OSS information DB with the collected OSS information; and
generating, by an SEM training module receiving the OSS project file from the OSS information DB, the SEM model.

7. The method of claim 6, wherein the first operation further comprises generating, by the SEM training module, the OSS embedding DB.

8. The method of claim 5, wherein the second operation comprises:
receiving, by the OSS information DB, new OSS information from an OSS monitoring module that monitors the world wide web (WWW);
updating the OSS information DB with the new OSS information;
forwarding, by the OSS information DB, the new OSS file to the SEM model; and
updating, by the SEM model, the OSS embedding DB with the new OSS file.

9. The method of claim 5, wherein the third operation comprises:
receiving, by a client module connected to the OSS embedding DB, an input project in accordance with an analysis target selection by a user terminal;
generating, by the SEM model, the input project embedding on the basis of the input project;
comparing, by the SEM model, the input project embedding with embeddings in the OSS embedding DB; and
receiving information on the identified OSS in accordance with comparison results from the OSS embedding DB.

10. The method of claim 5, further comprising a fourth operation of acquiring vulnerabilities or license information from the OSS information DB on the basis of information on the identified OSS and managing an OSS version.

11. The method of claim 10, wherein the fourth operation comprises:
receiving, by a web module interoperating with the OSS information DB, the information on the identified OSS from a client module connected to the OSS embedding DB;
querying the OSS information DB using the information on the identified OSS; and
receiving the vulnerabilities or the license information corresponding to the information on the identified OSS from the OSS information DB.

12. The method of claim 11, wherein the fourth operation further comprises transmitting the information on the identified OSS including the vulnerabilities or the license information to a user terminal.
